(19) United States
(12) Patent Application Publication
(10) Pub. No.: US 2026/0064437 A1
(43) Pub. Date: Mar. 5, 2026

(54) MULTI-PROCESSING UNIT STATUS AGGREGATION AND TRANSMISSION

(71) Applicant: Nvidia Corporation, Santa Clara, CA (US)

(72) Inventors: Patrick Fear, Beaverton, OR (US); William Ryan Weese, Portland, OR (US); Gena Rozenberg, Houston, TX (US); Ramanand Nayak, San Jose, CA (US); Ryan Albright, Beaverton, OR (US); Elad Mentovich, Tel Aviv (IL)

(21) Appl. No.: 18/825,709

(22) Filed: Sep. 5, 2024

(51) Int. Cl. G06F 9/445

(52) U.S. Cl. CPC G06F 9/44589

(57) ABSTRACT

Systems and methods are directed toward collecting, aggregating, arbitrating, and transmitting data streams from one or more different source locations. An intermediary system may be positioned between a central controller and a variety of source locations to receive data streams from the different source locations along independent data connections. The intermediary system may identify information for transport to a central controller along a separate connection while delaying or otherwise managing the remaining incoming data streams. Upon determining transmission is complete, the intermediary system may then select another data stream for processing while continuing to delay or manage the remaining incoming data streams.

### TECHNICAL FIELD

At least one embodiment pertains to boot processes for computing systems. More specifically, at least one embodiment pertains to aggregating information collected from a multi-processor system for efficient transmission to one or more controllers.

### BACKGROUND

Compute systems may include multi-socket architectures that may include multiple different processing units booting and/or operating in the systems at a given time. The processing units may function separately and/or may be associated with one or more common functions. In either operating condition, knowledge of boot processes, current operating conditions, and the like is important for understanding underlying health conditions for the system as a whole.

Typically, each socket associated with a processing unit has a dedicated bridge or communication pathway to one or more controllers. As a number of sockets increases for multi-processor systems, available communication pathways may not be able to scale while also effectively managing spacing and other requirements for the system. Additionally, certain communication pathways may be dedicated for particular functions, therefore further limiting how much data may be transmitted to various controllers, and moreover, how that data is presented so that the various controllers can effectively assign data to the proper processing unit for monitoring and potential trouble shooting.

### BRIEF DESCRIPTION OF THE DRAWINGS

Various embodiments in accordance with the present disclosure will be described with reference to the drawings, in which:

FIG. 1 illustrates an example environment including an intermediate aggregation and arbitration system for data transmissions, in accordance with at least one embodiment;

FIG. 2 illustrates an example environment including a multi-socket platform with an intermediate aggregation and arbitration system for data transmissions, in accordance with at least one embodiment;

FIG. 3A illustrates an example environment including a pair of multi-socket platforms with a bridge connecting respective intermediate aggregation and arbitration systems for data transmissions, in accordance with at least one embodiment;

FIG. 3B illustrates an example environment including a pair of multi-socket platforms with a bridge connecting respective intermediate aggregation and arbitration systems for data transmissions and additional connection interfaces, in accordance with at least one embodiment;

FIG. 4A illustrates an example call diagram for receiving, arbitrating, and transmitting data streams from a plurality of processing units, in accordance with at least one embodiment;

FIG. 4B illustrates an example environment including an intermediate aggregation and arbitration system, in accordance with at least one embodiment;

FIG. 5A illustrates an example process data collection, arbitration, and transmission, in accordance with at least one embodiment;

FIG. 5B illustrates an example process data collection, arbitration, and transmission, in accordance with at least one embodiment;

FIG. 5C illustrates an example process data collection, arbitration, and transmission, in accordance with at least one embodiment;

FIG. 6 illustrates components of a distributed system that can be utilized to update or perform inferencing using a machine learning model, according to at least one embodiment;

FIG. 7 illustrates an example data center system, according to at least one embodiment;

FIG. 8 illustrates a computer system, according to at least one embodiment;

FIG. 9 illustrates a computer system, according to at least one embodiment;

FIG. 10 illustrates at least portions of a graphics processor, according to one or more embodiments; and

FIG. 11 illustrates at least portions of a graphics processor, according to one or more embodiments.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

The systems and methods described herein may be used by, without limitation, non-autonomous vehicles or machines, semi-autonomous vehicles or machines (e.g., in an in-cabin infotainment or digital or driver virtual assistant application)), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, trains, underwater craft, remotely operated vehicles such as drones, and/or other vehicle types. Further, the systems and methods described herein may be used for a variety of purposes, by way of example and without limitation, for machine control, machine locomotion, machine driving, synthetic data generation, model training or updating, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational artificial intelligence (AI), generative AI with large language models (LLMs), light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems for performing generative AI operations using LLMs, systems for performing light transport simulation, systems for performing collaborative content creation for 3D assets, systems implemented at least partially using cloud computing resources, and/or other types of systems.

Approaches in accordance with various embodiments are directed toward an intermediary system to receive, arbitrate, and transmit information from a multi-processor system along a single communication channel. In at least one embodiment, an aggregator (e.g., a field programmable gate array (FPGA), an application-specific integrated circuit (ASIC), a system on chip (Soc); a complex programmable logic device (CPLD), etc.) may be positioned between a multi-processor configuration and a controller (e.g., a baseboard management controller (BMC), a central controller, a control unit, a control system, etc.). Normally, during a boot process as one non-limiting example, a processing unit (PU) generates boot progress codes and then transmits those codes via a direct connection (e.g., an inter integrated-circuit protocol (I2C)) to the controller. With multiple PUs, the direct communication channel may include boot progress codes from each of the PUs. Information from the individual PUs may be competing for transmission bandwidth or use of the line, and therefore it may be difficult to determine which codes are from which PU in the event of an error, and as a result, it may be difficult to use the boot progress codes for trouble shooting. Embodiments of the present disclosure eliminate the direct connection between the PUs and the controller and route the data originally transmitted over the direct connection to the aggregator. The aggregator may have more pins or available connections than the controller to allow individual PUs to transmit their boot progress codes over a dedicated thread. Upon receiving an indication of data transmission, the aggregator may select a first or “winning” data stream, verify the address, pass the data stream to the controller, and also clock stretch the remaining data streams from the other PUs until the first data stream is transmitted. Thereafter, the aggregator may select another data stream from a different PU until all of the information has been transmitted. Systems and methods may be expanded to include any reasonable number of PUs and/or aggregators to allow for growth of multi-chip/multi-socket platforms.

In at least one embodiment, systems and methods of the present disclosure may be directed toward a variety of different data transmissions associated with a multi-processor configuration and it should be appreciated that references to boot codes is by way of non-limiting example. For example, embodiments may further include collection, aggregation, and transmission of other types of information such as, but not limited to, debug codes, logging information, sensor information, and the like. Additionally, multiple threads or processes from multiple sources, both local and in aggregate from a plurality of upstream sources, could be collected, and in some embodiments modified with a source header, and passed from an applicable host processor, controller, and/or aggregator. Furthermore, one or more embodiments may be directed toward systems and methods that are associated with multi-socket systems, which may include one or more PUs, such as, for example, central processing units (CPUs), data processing units (DPUs), graphics processing units (GPUs), microcontrollers, management controllers, and/or any other program code executable logic device capable of maintaining and operating a state machine.

In at least one embodiment, systems and methods may be used to aggregate key information from multiple sockets into a singular management device. For example, multiple processing modules (e.g., processing systems that may include one or more PUs) may include data communication pathways that are fed into a common aggregator. The data communication pathways may be formed in place of previously used data communication pathways that may have shared a common or singular ingress port to a central controller. As a result, as data is generated and transmitted over the individual pathways, the aggregator may receive and manage the data prior to transmission to the central controller. In at least one embodiment, the aggregator includes more ports than the central controller, and as a result, may be better positioned to receive information from multiple sources, which may be particularly relevant as systems increase a number of sockets used to incorporate additional compute devices. Particular data communication pathways associated with the aggregator may be selected for certain types of information, such as one pathway for boot data, one for sensor data, one for debugging data, and/or the like. Additionally, data may be transmitted over a common pathway and a type of data may be labeled within a header or the like. Upon receipt of the data, or in anticipation of receiving the data, such as via one or more signals indicative of a command, the aggregator may receive and read a header or other address information for the data and then, in one or more embodiments, may collect and/or store the data in intermediate storage and/or may determine a singular data flow for forwarding to the central controller. For example, as data is transmitted to the aggregator, a “winner” of the race to the aggregator may be selected and then provided to the central controller. In at least one embodiment, the aggregator may use one or more features of the communication protocol to hold up or otherwise delay information from other sources. However, it should be appreciated that other data may be transmitted and/or stored in one or more memories prior to processing by the aggregator and/or the like. Upon determination that a data stream is complete, another stream may be selected for forwarding, such as using a round robin or other type of process to select the data for transmission. In this manner, multi-socket systems may use the increased flexibility of the aggregator to transmit information to the central controller.

Various embodiments of the present disclosure address and overcome problems with existing systems where singular problems with PUs, such as a CPU during boot, may delay or otherwise lock up various communication pathways between the PUs and the central controller. Moreover, embodiments further address problems associated with identifying relevant information within data streams that may be used for processes such as debugging, troubleshooting, and/or unit monitoring. In at least one embodiment, systems and methods are directed toward applications that may include one or more bootable entities, as one non-limiting example. During boot up, the PUs may produce a set of boot progress codes and the boot progress codes may be used to understand a status of the PU during the boot up process, which may be relevant in the event the boot does not complete successfully. For example, upon determining a boot error, boot values may be evaluated to determine boot progress and identify how far along the boot process the error occurred, which may be useful for debugging. However, as units are scaled with multiple sockets including multiple different PUs, the controller may only include a single port to receive a number of different progress codes from a number of different PUs. For example, an I2C link may be used to route the codes toward the controller. In operation, codes may become merged, and as a result, a sender of a particular code or portion of code may be difficult to identify in the event there is a boot error. Moreover, systems and methods address problems that may be associated with a shared or common communication line in which a PU may hang or otherwise drive a bus to zero volts, thereby preventing additional data transmission. In other words, embodiments of the present disclosure address problems where data transmission from one PU contends with transmission from another PU. Embodiments further address problems with respect to system architecture that may be port limited with respect to one or more controllers.

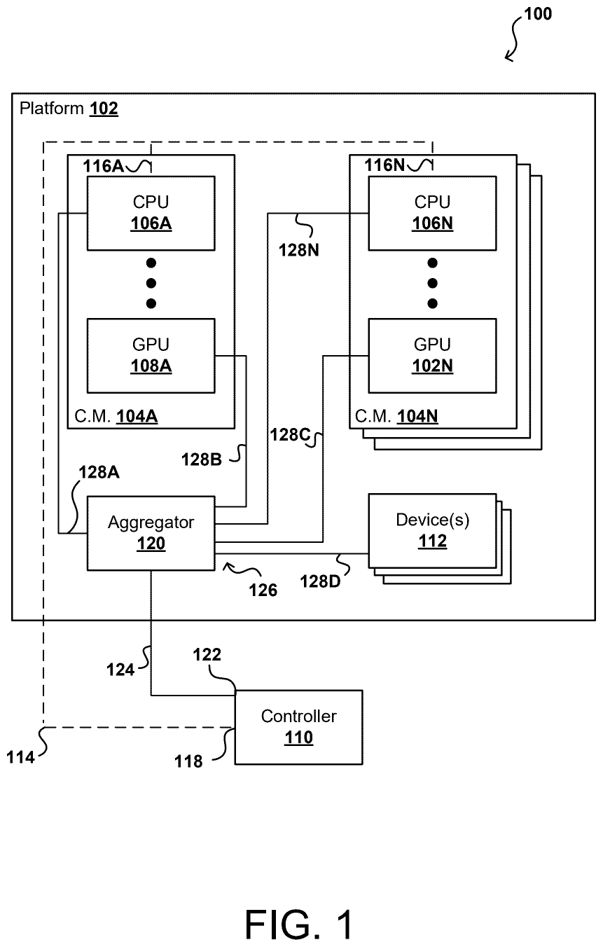

FIG. 1 illustrates an environment 100 that may be used with embodiments of the present disclosure. In this example, platform 102 includes a multi-socket configuration and further includes computing modules 104A-104N. Various embodiments may include more or fewer computing modules 104. The modules 104 in the illustrated configuration each include a pair of PUs, which in this example include respective CPUs 106 and GPUs 108. As discussed herein, the module 104 may include singular PUs or more PUs.

The platform 102 may be communicatively coupled to a controller 110 (e.g., central controller, BMC, etc.) that may be independent from and/or off-device from the platform 102. Additionally, the controller 110 may be integrated into the platform 102 in one or more embodiments. In at least one embodiment where the controller 110 is a BMC, the BMC may refer to a processor to remotely monitor a physical state of a host system, such as the platform 102 and/or components thereof. The controller 110 may use information from one or more sensors and may communicate with one or more administrators to notify the administrator regarding the state of the platform 102 and whether or not one or more actions may be needed based on different operating conditions.

The platform in this example also includes additional devices 112, such as various switches, sensors, on-platform management systems, peripheral device connections, memory, and/or the like. As discussed herein, embodiments of the present disclosure may address and overcome problems with traditional system configurations in which one or more systems or sub-systems may provide data via a direct, dedicated, and often shared, connection with the controller 110. By way of example, configurations may include a data connection 114 that may use one or more transmission protocols in order to carry information from the CPUs 106A, 106N to the controller 110. In one example, the data connection 114 may use an I2C connection that may, in various embodiments, transmit boot progress codes, among other information, to the controller 110. For the example associated with boot progress codes, the data connection 114 may be used in favor of other connections, such as other peripheral connections, because various other communication systems may not be provisioned or available until after boot is complete. In this example, a common data connection 114 includes respective inputs 116A, 116N from the CPUs 106A, 106B. As a result, only a single port 118 of the controller 110 is used by the data connection 114, but traffic flow may be mixed due to the use of a common connection, with the CPUs 106A, 106N competing with one another. As a result, in the event of a boot error, it may be difficult to identify boot progress code origins. Additionally, one of the CPUs 106A-106N could potentially lock up the connection 114 due to an error. However, running independent connections 114 to the controller 110 is unfeasible and cannot scale. Accordingly, embodiments of the present disclosure may incorporate an aggregator 120 to collect information from a variety of different PUs and then determine an ordering/manner in which to provide the information to the controller 110. Accordingly, the controller 110 only uses a single port 122 to receive the information from the aggregator 120 and problems associated with data collisions, locking, and the like are addressed due to the independent connections from the PUs to the aggregator 120, as discussed herein.

Systems and methods of the present disclosure may be used to modify an output interface associated with one or more devices, which may include the PUs, sensors, and/or the like, and route data discretely into the aggregator 120, which may be an FPGA or the like. The aggregator 120 may not be as pin-limited as the controller 110, and as a result, individual inputs may have their own dedicated connection. Furthermore, systems and methods may be used to link a number of aggregators together, which may further enable additional system scaling without changing pin configurations for the controller 110. In at least one embodiment, the aggregator 120 may be described as an arbiter. For example, the aggregator 120 may serve to determine a source device that first initiates bus activity via a start address to determine which source device first provides information to the controller 110. The remaining devices, for example devices that initiate after the first source device, may wait, such as being held using clock stretching, and then the aggregator 120 may move to the next source device using one or more rules. Accordingly, embodiments may provide the aggregator 120 to both collect the data and then to manage its transmission to the controller 110.

In this example, the port 122 is associated with a connection 124 between the aggregator 120 and the controller 110. As discussed herein, a single connection may still be formed at the controller 110, but now instead of competing data along the connection, data transmission may be managed by the aggregator 120, for example after arbitrating a transmission order. The illustrated aggregator 120 includes more pins 126, and as a result, each individual upstream component may have its own connection 128A-N. It should be appreciated that, in some embodiments, connections 128 may be shared due to design considerations or desired operating conditions, but this example illustrates independent connections 128A-N formed at the pins 126 of the aggregator 120.

In operation, as components boot/sensor data is transmitted/data is provided to the aggregator 120, the aggregator 120 may identify activity on a bus, identify a start sequence and/or address for a given component, and then pass through data on a byte basis. For example, an entire byte of data may be aggregated and then retransmitted to the controller 110, while holding off the other data, such as using a clock stretch for another I2C connection. Additionally, in at least one embodiment, the aggregator 120 may further include a buffer or other memory in order to collect data until transmission of a first set or sequence of data is complete. In this manner, collision of data and/or zeroing of buses may be reduced or eliminated because independent connections formed upstream of the controller 110 may be routed to a device with fewer pin restrictions and circuitry and logic to receive, identify, maintain, and route different data communications. Accordingly, the connections 114 may be eliminated while maintaining the functionality associated with gathering information from the individual PUs and/or other devices.

Systems and methods of the present disclosure may be directed toward processing circuity that may be used to receive, from a set or group of PUs, such as CPUs, a plurality of input signals corresponding to respective boot progress codes. A first input signal may be selected from the plurality, for example based on a start sequence and address. The first input signal may then be transmitted, for example on a byte-basis, to a central controller or other receive while the processing circuitry uses features of the transmission protocol, such as I2C, to execute a clock stretch for other input signals from different PUs in the set. In operation, when an end sequence for the first signal is identified, a second input signal from the set may be selected and transmitted. During transmission of the second input signal, the clock stretch may be maintained for the remaining input signals for the other PUs. In at least one embodiment, the second input signal may be selected based on one or more rules, such as a round robin rule, a weighted selection rule, or a combination thereof. Additionally, as discussed herein, embodiments may incorporate one or more intermediate memory devices or a buffer to store one or more input signals. In at least one embodiment, the processing circuity may be part of one or more devices, which may include at least one of an FPGA, an ASIC, a SoC, or a CPLD.

Various embodiment of the present disclosure may overcome problems associated with managing input signals from a variety of different data sources, such as PUs. The PUs may each include one or more output data paths to transmit signals. Additionally, one or more embodiments may also be addressed toward managing signals from sensors and/or other peripheral devices, as discussed herein. A controller may include a BMC that receives the processor information. However, the BMC may have a finite number of pins to receive data connections that cannot be readily scaled. Accordingly, embodiments may incorporate one or more intermediaries, which may be referred to an aggregator, to receive signals from the PUs upstream of the BMC, arbitrate the input data signals, and then pass data to the BMC. As discussed herein, the information signals from the PUs may include information such as boot codes, debug codes, logging data, or sensor information. Furthermore, information may be transmitted with a source header identifying the source PU, providing a start address, and/or the like. Various different communication protocols and/or interfaces may be used with embodiments of the present disclosure, such as at least one of an inter integrated-circuit (I2C), a serial peripheral interface (SPI) communication protocol, a universal asynchronous receiver/transmitter (UART) communication protocol, a system management bus (SMBus) communication protocol, or an improved inter integrated-circuit (I3C) communication protocol.

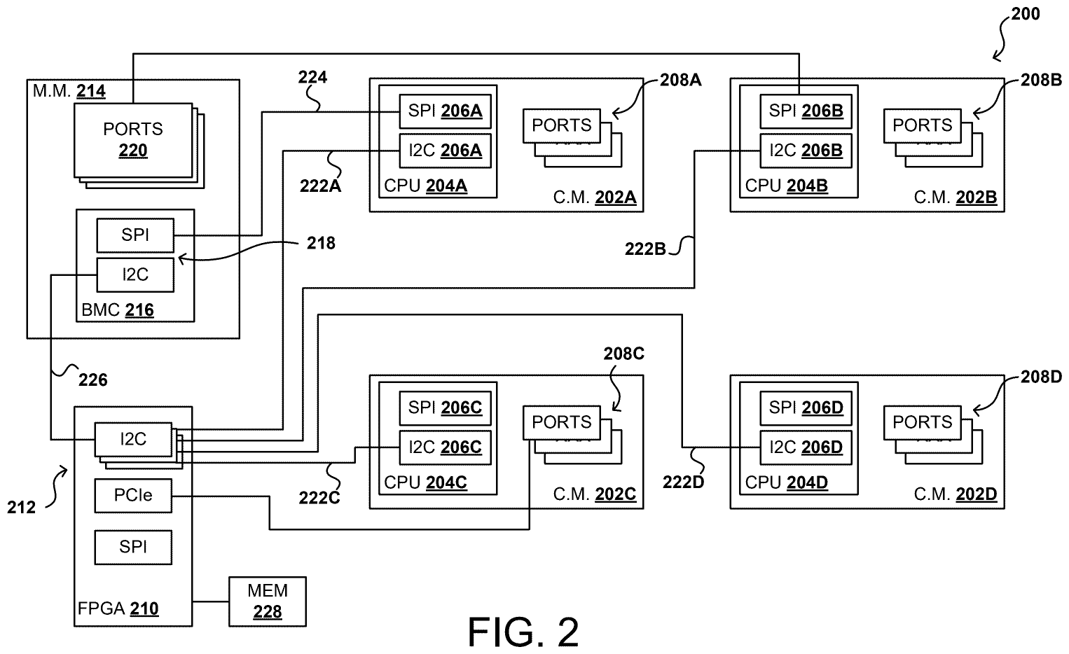

FIG. 2 illustrates an example environment that may be used with embodiments of the present disclosure. In this example, a computer system 200 that includes a four-socket setup is illustrated. As discussed herein, embodiments of the present disclosure may be directed toward systems that methods that enable one or more PUs to be coupled to an intermediary, such as an aggregator, to provide a managed connecting to one or more controllers, which may be local controllers or distributed controllers. While the illustrated example of FIG. 2 includes specific configurations and protocols for respective ports, these labels are provided by way of non-limiting example for clarity with the present discussion and are not intended to limit the scope, as different configurations, different communication protocols, different compute units, and the like may be used within the scope of various embodiment discussed herein. This example includes a plurality of computing modules 202A-D, which may share one or more features with the modules 104A-104N of FIG. 1. Each individual module 202A-202D includes a PU 204, which in this example is a CPU, ports 206 associated with the CPU, and ports 208 associated with one or more additional components of the module 104. For clarity, different components and/or ports may be labeled with respective letters of their respective modules. For example, the module 104A may include the CPU 204A, the ports 206A, the ports 208A, and so forth.

As shown herein, the ports 206A are labeled with specific communication protocols and various embodiments may include additional or alternative protocols or interfaces, as discussed here. For example, the configuration in FIG. 2 illustrates both I2C and SPI, but other embodiments may also be implemented using various interfaces and/or protocols, such as PCIe, UART, USB, and/or the like. The illustrated example further includes an aggregator, which in this example is an FPGA 210. As discussed herein, the use of the FPGA is by way of non-limiting example. In at least one embodiment, the FPGA 210 includes a number of different ports 212, which may be of a variety of types/interfaces/protocols, including the illustrated examples of I2S, PCIe, and SPI, among others not illustrated for clarity and conciseness. As discussed herein, embodiments may be directed toward using the FPGA 210 as an intermediary between the various computing modules 202A-202D and a management module 214, which may include a controller, such as the BMC 216 that has a set of ports 218, along with one or more additional ports 220.

In at least one embodiment, systems and methods of the present disclosure may include configurations in which the one or more compute modules 202A may include multiple outlet data paths and one or more may directly couple to the BMC 216 while another uses the FPGA 210 as an aggregator/arbiter. Various embodiments may establish certain communications that are intended for direct connection, and may include specific protocols for such connections, while others are routed through the FPGA 210. For example, in the configuration of FIG. 2, the I2C protocols that may be used to transmit boot progress codes are routed through the FPGA 210, as shown by the connection 222A, while another connection 224 using the SPI protocol is directly coupled to one or more ports 218 of the BMC 216. In this manner, certain routing configurations may be maintained while also providing flexibility for different socket configurations.

In the illustrated configuration, individual I2C ports 206 of each of the CPUs 204A-204D are coupled to the FPGA 210 using one or more connections 222A-222D. The connections 222A-222D, in one non-limiting example, may be used to transmit boot progress codes during boot sequences for the CPUs 204A-204B. For example, during boot each of the CPUs 204A-204D may generate boot progress codes that can be used for later troubleshooting to identify state information for the respective CPUs 204. Traditionally, a common communication channel would be used by all CPUs 204A-204D to directly transmit progress codes to the BMC 216. However, as discussed herein, the traditional configuration has problems with data mixing, potential lock outs, and the like. By separating each of the boot progress codes to a separate communication line and routing the data transmission through the intermediary FPGA 210, embodiments of the present disclosure may enable aggregation and arbitration of different data streams, thereby managing which data is processed by the BMC 216 at particular times. For example, as data streams are transmitted to the FPGA 210, a determination may be made to identify a first stream, such as by using a start sequence and verifying an address. The first data stream, or some other stream based on one or more ordering or transmission rules, may then be transmitted on a byte basis, for example after aggregating some portion of data, to the BMC 216 via a connection 226, which in this example is an I2C connection. After transmission, a second data stream may be identified, selected, transmitted, and so forth.

In certain embodiments, a buffer or one or more memories 228 may be used to store data or data streams. For example, certain communication protocols may not include functionality to perform actions like clock stretching. Accordingly, systems and methods may store the information, such as boot progress codes, within intermediate storage, which may be internal to the FPGA 210 and/or external memory 228. In this manner, embodiments of the present disclosure may be used to collect, store, and determine a time to provide different data to the BMC 216.

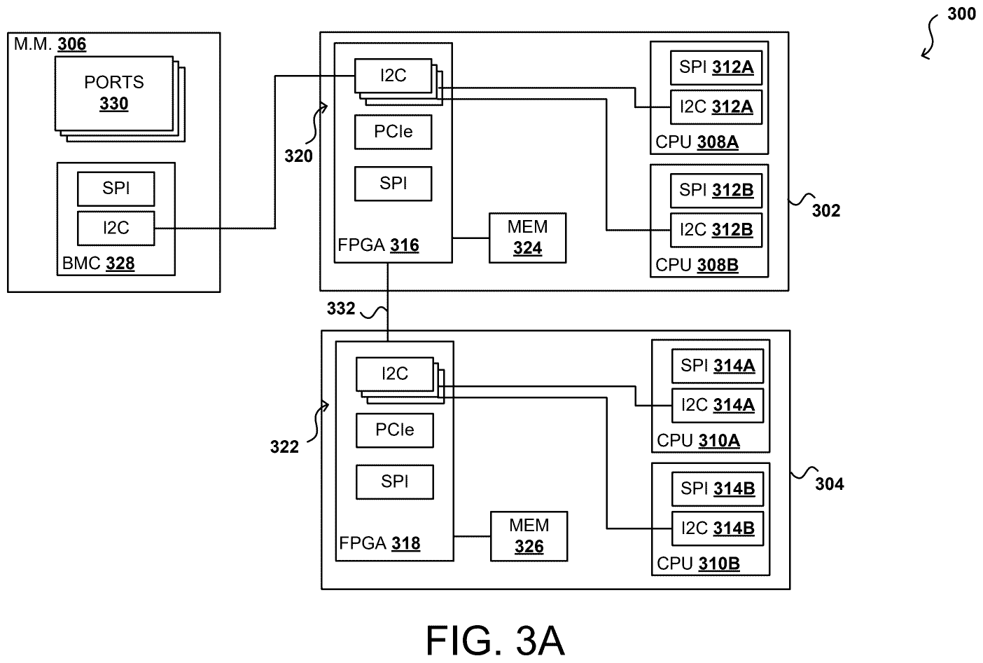

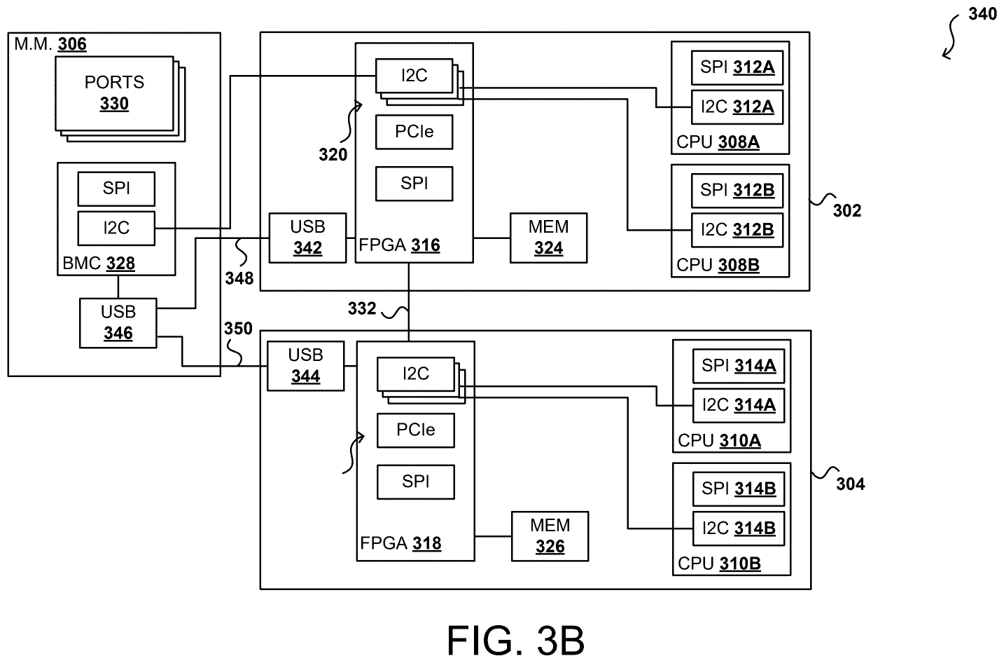

FIG. 3A illustrates an environment 300 that may be used with embodiments of the present disclosure in which a first platform 302 and a second platform 304 are each coupled to a common management module 306. As discussed herein, various features of FIG. 3A may share one or more components with FIGS. 1 and 2. This example includes the first platform 302 having PUs 308A, 308B represented as CPUs. Similarity, the second platform 304 includes PUs 310A, 310B also represented as CPUs. The platforms 302, 304 each may have more or fewer PUs, and moreover, may also include additional or alternative components that may generate information for use by the management module 306, such as sensors and the like. Additionally, the first platform 302 and the second platform 304 may not have the same number of PUs or other components and may also be associated with different configurations.

Each of the CPUs 308A, 308B, 310A, 310B include respective ports 312, 314 that may be configured to transmit information and/or data using one or more protocols and/or interfaces. The illustrated embodiments includes reference to SPI and I2C connections, but it should be appreciated that various other connections may be included within the scope of the present disclosure. In this example, each of the platforms 302, 304 further include independent aggregators 316, 318, which in this non-limiting example are shown as FPGAs. As discussed herein, various additional or alternative components may be used within the scope of the present disclosure, such as one or more processing units that may serve to receive inputs from various platform components, aggregate and/or arbitrate the information, and then transmit the information to a second and/or third component, among other options. The respective FPGAs 316, 318 each include sets of ports 320, 322, which may receive inputs from a variety of different systems and/or may be used to transmit information to a variety of different systems. For example, the FPGAs 316, 318 may be used as an intermediary for instructions or signals from the management module 306. Additionally, the FPGAs 316, 320 may contain or have access to additional logic that may be used to execute commands associated with operation of the platforms 302, 304. Furthermore, one or both of the FPGAs 316, 318 may be associated with or include one or more memories 324, 326, which may be internal memory, such as a buffer, or an external memory device. The memories 324, 326 may be used to store incoming data, at least temporarily, until the FPGAs 316, 318 determine and/or select the data for further transmission.

One or more embodiments may be used to reduce a number of connections formed at a controller of the management module 306, which in this example is a BMC 328. The management module 306 may also include additional components or ports 330 associated with additional components. By using the FPGAs 316, 318 as one or more intermediaries for signals from and/or associated with the platforms 302, 304, a number of connections formed at the BMC 328 may be reduced to one, which may enable scaling because the BMC 328 may have a finite or limited number of ports that may reasonably be incorporated into its design. Accordingly, systems and methods may be used to provide an intermediate aggregator/arbiter to receive data and select data for further transmission by using one or more components with additional ports that may enable independent connections to a variety of components, thereby reducing or eliminating problems associated with shared connections at the BMC 328.

In this example, the FPGAs 316, 318 are coupled together via a platform connection 332. The platform connection 332 may be used to transmit data that has been received at the FPGA 318 from the CPUs 310A, 310B (and any other additional components sending information to the FPGA 318) and to be added as part of the arbitration with the other data also received at the FPGA 316 with respect to the components of the platform 302. Accordingly, by chaining the FPGAs 316, 318 and configuring one to act as the main connection to the BMC 328, the number of connections to the BMC 328 remains the same (e.g., one), while the number of components added to the system overall may be increased, thereby further enabling scaling without affecting the BMC 328 with respect to ports and/or other configuration settings.

FIG. 3B illustrates an example environment 340 that may be used with embodiments of the present disclosure. This example configuration includes the platforms 302, 304 with the addition of respective universal serial bus (USB) hubs 342, 344. In this example, the USB hubs 342, 344 are each configured to independently connect the respective platforms 302, 304 to the management module 306 at a management USB hub 346 via USB connections 348, 350. Accordingly, systems and methods may use additional and/or alternative connections between the respective platforms 302, 304 and the management module 306 to provide data, such as information generated during a boot process, sensor data, and/or the like.

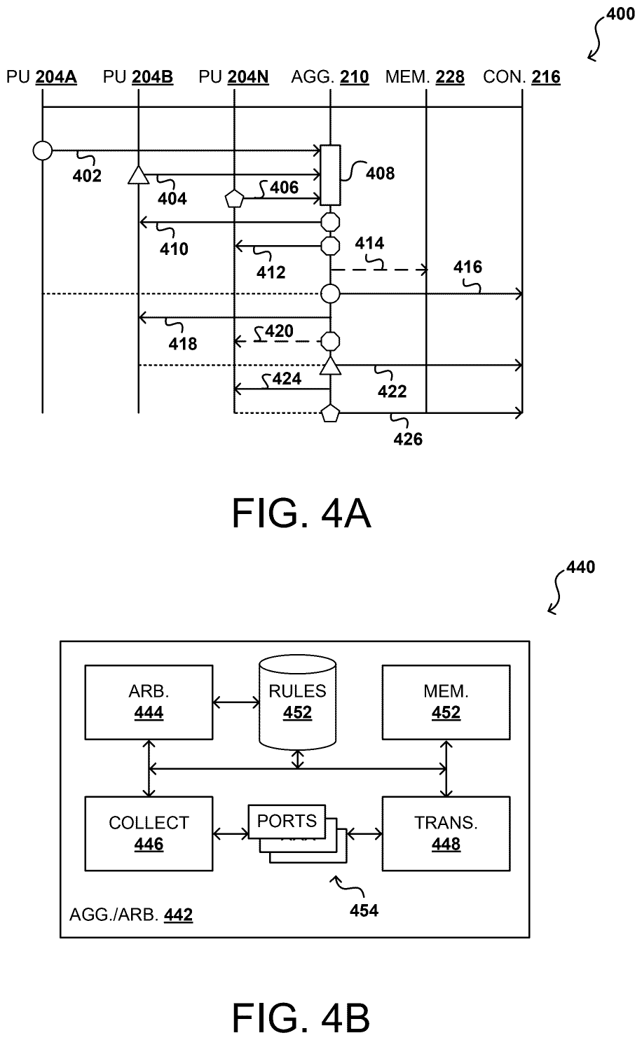

FIG. 4A illustrates an example diagram 400 that may be used with embodiments of the present disclosure. The example diagram may illustrate different calls, actions, responses, and the likes that may incorporate one or more embodiments discussed herein, such as those in FIGS. 1-3B. Various embodiments may include additional elements or steps and the illustrated diagram is provided by way of non-limiting example for clarity and simplicity. In this example, three different PUs 204A, 204B, and 204N are illustrated, but there may be more or fewer. The PUs may correspond to a variety of different components and systems, such as CPUs, GPUs, DPUs, and the like. Furthermore, the use of PUs is an example, and other data transmission may occur from other devices, such as various sensors and/or the like. Accordingly embodiments of the present disclosure may be directed toward one or more systems that may collect, arbitrate, and then transmit data from a variety of different data sources that may transmit information using a variety of different transmission protocols and/or interfaces.

In this example, each of the PUs 204A, 204B, 204N transmits a respective data stream 402, 404, 406. In this example, the data for the individual PUs 204 is represented by a shape, with the data for the PU 204A being a circle, the data for the PU 204B being a triangle, and the data for the PU 204N being a pentagon. The data streams are received and processed 408 at the aggregator 210, which as noted herein, may be an FPGA or some other device capable of receiving incoming data streams, determining a source and/or time or arrival, and arbitrating further actions with the data streams. In at least one embodiment, the data streams may be selected based on a “first” to arrive. For example, as bus activity is recognized, the aggregator 210 may identify a source based on information, such as a start sequence or address associated with a header, and may select that data stream. In another embodiment, the aggregator 210 may receive streams, wait for a period of time, and then select a stream based on one or more rules, among other options.

In this example, the aggregator 210 selects the data stream associated with the PU 204A and then transmits clock stretches 410, 412 to each of the PUs 208B, 204N, as represented by the octagons. The clock stretches may be a factor of the communication protocol used to transmit the data streams, such as I2C. However, in other embodiments, the clock stretches may be a command to stop or wait to transmit data for a period of time or until another signal is received to transmit data. In at least one embodiment, the aggregator 210 may optionally transmit 414 some or all of the data streams to the memory 228, which may represent an internal buffer and/or an external memory device.

Systems and methods may be used to aggregate and then transmit information associated with the PU 204A as the selected data stream. For example, data may be collected and then transmitted 416 to the controller 216, which may include a BMC or other control device. As shown, the data may be transmitted directly from the aggregator 210, for example after collection, and/or may be directly from the PU 204A with the aggregator 210 serving as a pass through. Upon completion of the transmission, or upon receiving one or more stop signals, the aggregator 210 may release or otherwise end 418 the stop signal for the PU 204B, based on the rules for selecting the subsequent stream. Although the stop signal is ended for the PU 204B, it may be maintained or reinstituted 420 for the PU 204N. The aggregator 210 may then collect and/or otherwise facilitate transmission 422 of the data from the PU 204B. Upon completion of the transmission, or upon receiving one or more stop signals, the aggregator 210 may release or otherwise end 424 the stop signal for the PU 204N, based on the rules for selecting the subsequent stream. The aggregator 210 may then collect and/or otherwise facilitate transmission 426 of the data from the PU 204N.

FIG. 4B illustrates an example environment 440 that may be used with embodiments of the present disclosure. The illustrated environment correspond to one or more features associated with an aggregator/arbiter 442, such as the aggregator 210 discussed herein. In one or more embodiments, the aggregator/arbiter 442 correspond to one or more programmable or special-purpose processing components that may be used to execute one or more software instructions, receive and/or transmit data, and/or the like. This example configuration includes an arbitration engine 444, a collection engine 446, a transmission service 448, a memory 450, a rules datastore 452, and a set of ports 454. As discussed herein, the set of ports 454 may refer to inbound or outbound ports that may incorporate a number of different transmission protocols and/or interfaces.

In operation, the arbitration engine 444 may be used to determine which data stream, from a set of incoming data streams, is selected for further processing and/or transmission. For example, one or more rules from the rules datastore 452 may be implemented in order to select a stream. Certain embodiments may include a rules such as selecting a first to provide bus activity and/or the like. Additionally, after transmission of one data stream, a round robin process may be used, a weighted process may be used, or a variety of other data arbitration rules to select and transmit data streams from a variety of different sources. The collection engine 446 may be used to collect and aggregate information, which may be used to generate a package for transmission to one or more downstream components via the transmission service 448 and/or may be sent to the memory 452, such as to a buffer. In at least one embodiment, transmission protocols selected by the transmission service 448 for the ports 454 may be obtained from the rules datastore 452. In this manner, the aggregator/arbiter 442 may receive information, determine an order to process the information, collect information, and then transmit the information to one or more downstream locations.

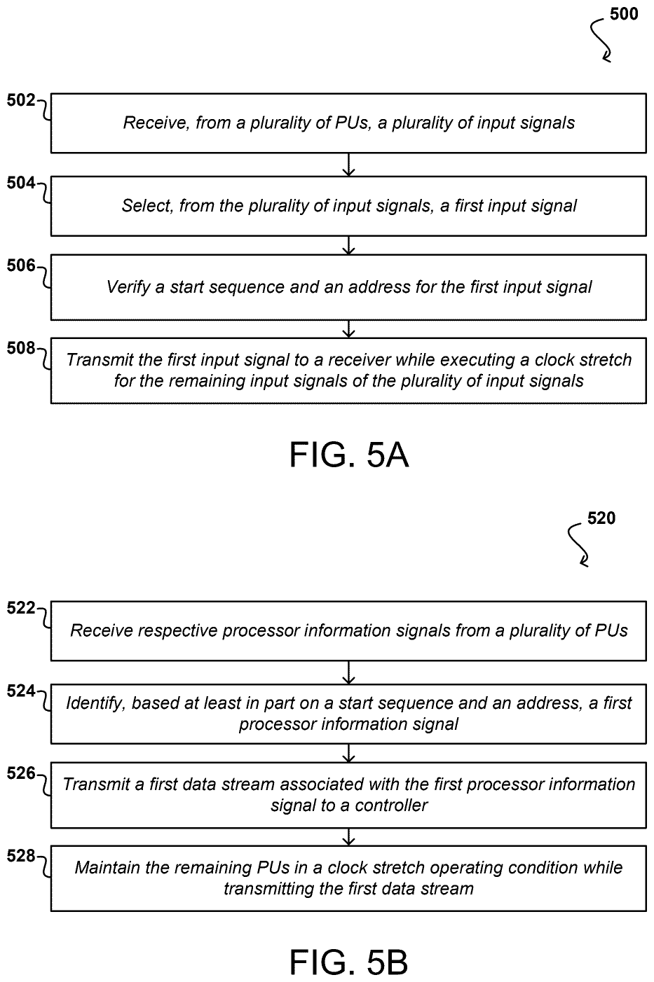

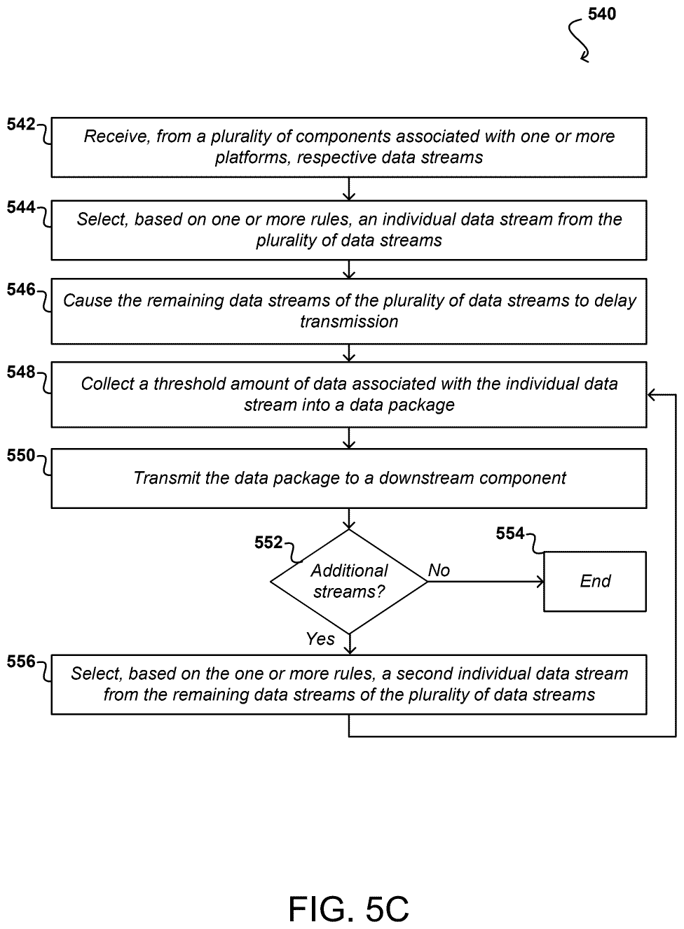

FIG. 5A illustrates an example process 500 that can be used to transmit signals from one or more PUs, in accordance with embodiments of the present disclosure. It should be understood that for this and other processes presented herein that there may be additional, fewer, or alternative operations performed in similar or alternative orders, or at least partially in parallel, within the scope of the various embodiments unless otherwise specifically stated. In this example, a plurality of input signals are received from a plurality of PUs 502. The input signals may include signals such as boot progress codes, debugging codes, troubleshooting information, and/or combinations thereof. The input signals may be received at a variety of different times throughout different states of a platform or computing device, such as during boot, during operation, during shut down, and/or combinations thereof. In certain embodiments, the input signals may include identifying information, for example within a header, that may provide information regarding a type of data within the input signals, a source of the data, and/or the like. In at least one embodiment, the input signals are provided along independent data connections to the plurality of PUs, but various embodiments may also incorporate shared or partially shared data connections.

A first input signal may be selected from the plurality of input signals 504. Selection may be based on one or more rules. Additionally, selection may be random or may be based on order of delivery, among other options. A start sequence and an address may be verified for the first input signal 506. For example, a header may be evaluated to determine a source for the input signal and/or determine a type of information included within the first input signal. The first input signal may then be transmitted to a receiver 508. In at least one embodiment, during transmission of the first input signal, the remaining input signals may be held in a clock stretch. For example, the clock stretch may be part of the I2C protocol and may slow down or halt I2C communications. Accordingly, systems and methods may be used to collect a number of signals, select a signal for transmission, and pause the other signals while the selected signal is transmitted.

FIG. 5B illustrates an example process 520 that can be used to transmit signals from one or more PUs, in accordance with embodiments of the present disclosure. In this example, processor information is received from a plurality of PUs 522. As one example, the processor information may correspond to one or more boot progress codes, among other potential information. A first signal from the plurality of signals may be identified 524. For example, a signal may be identified using information contained within the signal, such as a start sequence or an address within a header. A first data stream with the first processor information may then be transmitted 526. For example, a downstream controller may be a destination from an intermediate service to transmit the signal. While the first data stream is transmitted, the remaining signals of the plurality of signals may be held in a clock stretch 528. In this manner, transmission from other sources can be paused or delayed while the first data stream is transmitted.

FIG. 5C illustrates an example process 540 that can be used to select and transmit signals, in accordance with embodiments of the present disclosure. In this example, a plurality of components may transmit respective data streams that are received at one or more aggregators/arbitrators 542. The data streams may be associated with components from a variety of platforms and may include processor information, machine states, sensor data, and/or combinations thereof. In various embodiments, the data streams may be transmitted using different protocols and/or interfaces. In at least one embodiment, an individual data stream is selected from the plurality of data streams 544. For example, one or more rules may be used to determine and/or select which stream to process from the plurality of data streams. Upon selecting the individual data stream, the remaining data streams may be delayed or stopped 546. For example, a clock stretch operation may be initiated. As another example, a signal may be transmitted to the source to delay or hold transmission. It should be appreciated that in other embodiments, instead of delaying the signal, the remaining signal data may be stored, at least temporarily, within a memory location, such as a buffer or external memory.

A threshold amount of data may be collected from the individual data steam and formed into a data package 548. For example, downstream data transmission may be on a byte-level while transmission into the system may be on a bit-level. Accordingly, data may be collected and aggregated to send more data within individual packages. The data package may then be transmitted to a downstream component 550, such as a controller. It may then be determined whether there are additional data streams 552. If not, the process may end 554. If so, then one or more rules may be used to select another individual data stream from the remaining data streams for transmission to the downstream component 556. As a result, the process may repeat through the plurality of data streams until all or substantially all are transmitted and/or until some other stop condition is reached.

As discussed, aspects of various approaches presented herein can be lightweight enough to execute on a device such as a client device, such as a personal computer or gaming console, in real time. Such processing can be performed on, or for, content that is generated on, or received by, that client device or received from an external source, such as streaming data or other content received over at least one network. In some instances, the processing and/or determination of this content may be performed by one of these other devices, systems, or entities, then provided to the client device (or another such recipient) for presentation or another such use.

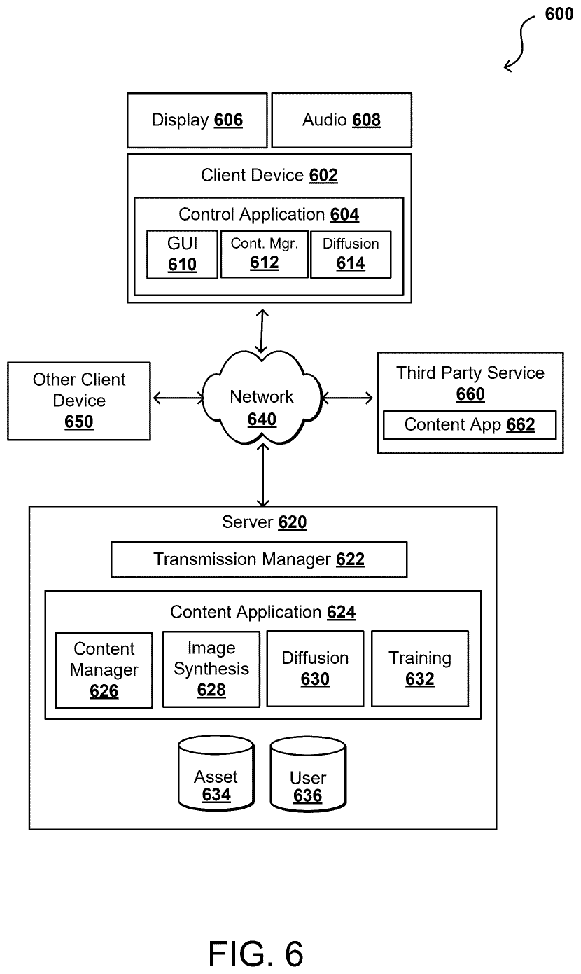

As an example, FIG. 6 illustrates an example network configuration 600 that can be used to provide, generate, modify, encode, process, and/or transmit image data or other such content. In at least one embodiment, a client device 602 can generate or receive data for a session using components of a control application 604 on client device 602 and data stored locally on that client device. In at least one embodiment, a content application 624 executing on a server 620 (e.g., a cloud server or edge server) may initiate a session associated with at least one client device 602, as may utilize a session manager and user data stored in a user database 636, and can cause content such as one or more digital assets (e.g., object representations) from an asset repository 634 to be determined by a content manager 626. A content manager 626 may work with an image synthesis module 628 to generate or synthesize new objects, digital assets, or other such content to be provided for presentation via the client device 602. In at least one embodiment, this image synthesis module 628 can use one or more neural networks, or machine learning models, which can be trained or updated using a training module 632 or system that is on, or in communication with, the server 620. This can include training and/or using a diffusion model 630 to generate content tiles that can be used by an image synthesis module 628, for example, to apply a non-repeating texture to a region of an environment for which image or video data is to be presented via a client device 602. At least a portion of the generated content may be transmitted to the client device 602 using an appropriate transmission manager 622 to send by download, streaming, or another such transmission channel. An encoder may be used to encode and/or compress at least some of this data before transmitting to the client device 602. In at least one embodiment, the client device 602 receiving such content can provide this content to a corresponding control application 604, which may also or alternatively include a graphical user interface 610, content manager 612, and image synthesis or diffusion module 614 for use in providing, synthesizing, modifying, or using content for presentation (or other purposes) on or by the client device 602. A decoder may also be used to decode data received over the network 640 for presentation via client device 602, such as image or video content through a display 606 and audio, such as sounds and music, through at least one audio playback device 608, such as speakers or headphones. In at least one embodiment, at least some of this content may already be stored on, rendered on, or accessible to client device 602 such that transmission over network 640 is not required for at least that portion of content, such as where that content may have been previously downloaded or stored locally on a hard drive or optical disk. In at least one embodiment, a transmission mechanism such as data streaming can be used to transfer this content from server 620, or user database 636, to client device 602. In at least one embodiment, at least a portion of this content can be obtained, enhanced, and/or streamed from another source, such as a third party service 660 or other client device 650, that may also include a content application 662 for generating, enhancing, or providing content. In at least one embodiment, portions of this functionality can be performed using multiple computing devices, or multiple processors within one or more computing devices, such as may include a combination of CPUs and GPUs.

In this example, these client devices can include any appropriate computing devices, as may include a desktop computer, notebook computer, set-top box, streaming device, gaming console, smartphone, tablet computer, VR headset, AR goggles, wearable computer, or a smart television. Each client device can submit a request across at least one wired or wireless network, as may include the Internet, an Ethernet, a local area network (LAN), or a cellular network, among other such options. In this example, these requests can be submitted to an address associated with a cloud provider, who may operate or control one or more electronic resources in a cloud provider environment, such as may include a data center or server farm. In at least one embodiment, the request may be received or processed by at least one edge server, that sits on a network edge and is outside at least one security layer associated with the cloud provider environment. In this way, latency can be reduced by enabling the client devices to interact with servers that are in closer proximity, while also improving security of resources in the cloud provider environment.

In at least one embodiment, such a system can be used for performing graphical rendering operations. In other embodiments, such a system can be used for other purposes, such as for providing image or video content to test or validate autonomous machine applications, or for performing deep learning operations. In at least one embodiment, such a system can be implemented using an edge device, or may incorporate one or more Virtual Machines (VMs). In at least one embodiment, such a system can be implemented at least partially in a data center or at least partially using cloud computing resources.

### Data Center

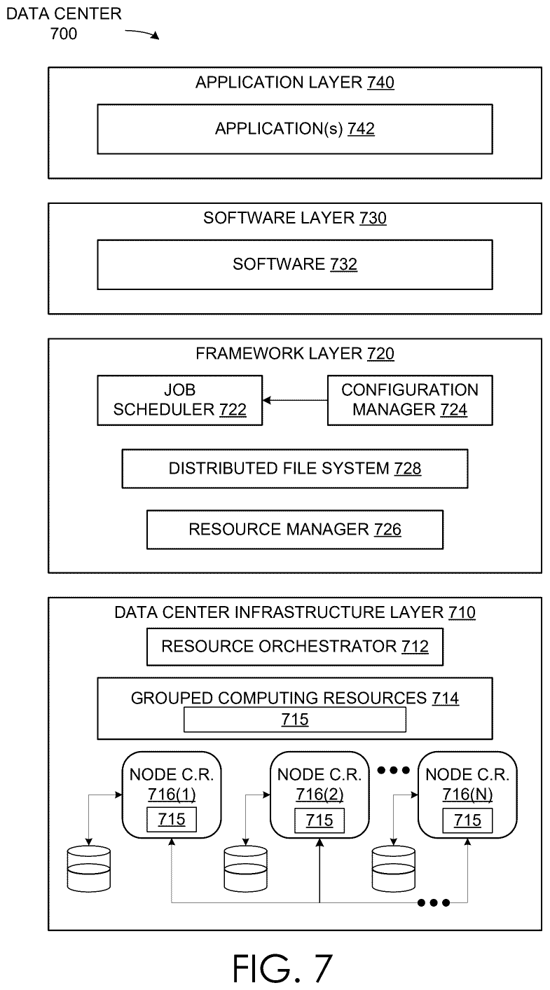

FIG. 7 illustrates an example data center 700, in which at least one embodiment may be used. In at least one embodiment, data center 700 includes a data center infrastructure layer 710, a framework layer 720, a software layer 730, and an application layer 740.

In at least one embodiment, as shown in FIG. 7, data center infrastructure layer 710 may include a resource orchestrator 712, grouped computing resources 714, and node computing resources (“node C.R.s”) 716(1)-716(N), where “N” represents any whole, positive integer. In at least one embodiment, node C.R.s 716(1)-716(N) may include, but are not limited to, any number of central processing units (“CPUs”) or other processors (including accelerators, field programmable gate arrays (FPGAs), graphics processors, etc.), memory devices (e.g., dynamic read-only memory), storage devices (e.g., solid state or disk drives), network input/output (“NW I/O”) devices, network switches, virtual machines (“VMs”), power modules, and cooling modules, etc. In at least one embodiment, one or more node C.R.s from among node C.R.s 716(1)-716(N) may be a server having one or more of above-mentioned computing resources.

In at least one embodiment, grouped computing resources 714 may include separate groupings of node C.R.s housed within one or more racks (not shown), or many racks housed in data centers at various geographical locations (also not shown). Separate groupings of node C.R.s within grouped computing resources 714 may include grouped compute, network, memory or storage resources that may be configured or allocated to support one or more workloads. In at least one embodiment, several node C.R.s including CPUs or processors may grouped within one or more racks to provide compute resources to support one or more workloads. In at least one embodiment, one or more racks may also include any number of power modules, cooling modules, and network switches, in any combination.

In at least one embodiment, resource orchestrator 712 may configure or otherwise control one or more node C.R.s 716(1)-716(N) and/or grouped computing resources 714. In at least one embodiment, resource orchestrator 712 may include a software design infrastructure (“SDI”) management entity for data center 700. In at least one embodiment, resource orchestrator may include hardware, software or some combination thereof.

In at least one embodiment, as shown in FIG. 7, framework layer 720 includes a job scheduler 722, a configuration manager 724, a resource manager 726 and a distributed file system 728. In at least one embodiment, framework layer 720 may include a framework to support software 732 of software layer 730 and/or one or more application(s) 742 of application layer 740. In at least one embodiment, software 732 or application(s) 742 may respectively include web-based service software or applications, such as those provided by Amazon Web Services, Google Cloud and Microsoft Azure. In at least one embodiment, framework layer 720 may be, but is not limited to, a type of free and open-source software web application framework such as Apache Spark™ (hereinafter “Spark”) that may use distributed file system 728 for large-scale data processing (e.g., “big data”). In at least one embodiment, job scheduler 722 may include a Spark driver to facilitate scheduling of workloads supported by various layers of data center 700. In at least one embodiment, configuration manager 724 may be capable of configuring different layers such as software layer 730 and framework layer 720 including Spark and distributed file system 728 for supporting large-scale data processing. In at least one embodiment, resource manager 726 may be capable of managing clustered or grouped computing resources mapped to or allocated for support of distributed file system 728 and job scheduler 722. In at least one embodiment, clustered or grouped computing resources may include grouped computing resource 814 at data center infrastructure layer 710. In at least one embodiment, resource manager 726 may coordinate with resource orchestrator 712 to manage these mapped or allocated computing resources.

In at least one embodiment, software 732 included in software layer 730 may include software used by at least portions of node C.R.s 716(1)-716(N), grouped computing resources 714, and/or distributed file system 728 of framework layer 720. The one or more types of software may include, but are not limited to, Internet web page search software, e-mail virus scan software, database software, and streaming video content software.

In at least one embodiment, application(s) 742 included in application layer 740 may include one or more types of applications used by at least portions of node C.R.s 716(1)-716(N), grouped computing resources 714, and/or distributed file system 728 of framework layer 720. One or more types of applications may include, but are not limited to, any number of a genomics application, a cognitive compute, and a machine learning application, including training or inferencing software, machine learning framework software (e.g., PyTorch, TensorFlow, Caffe, etc.) or other machine learning applications used in conjunction with one or more embodiments.

In at least one embodiment, any of configuration manager 724, resource manager 726, and resource orchestrator 712 may implement any number and type of self-modifying actions based on any amount and type of data acquired in any technically feasible fashion. In at least one embodiment, self-modifying actions may relieve a data center operator of data center 700 from making possibly bad configuration decisions and possibly avoiding underused and/or poor performing portions of a data center.

In at least one embodiment, data center 700 may include tools, services, software or other resources to train one or more machine learning models or predict or infer information using one or more machine learning models according to one or more embodiments described herein. For example, in at least one embodiment, a machine learning model may be trained by calculating weight parameters according to a neural network architecture using software and computing resources described above with respect to data center 700. In at least one embodiment, trained machine learning models corresponding to one or more neural networks may be used to infer or predict information using resources described above with respect to data center 700 by using weight parameters calculated through one or more training techniques described herein.

In at least one embodiment, data center may use CPUs, application-specific integrated circuits (ASICs), GPUs, FPGAs, or other hardware to perform training and/or inferencing using above-described resources. Moreover, one or more software and/or hardware resources described above may be configured as a service to allow users to train or performing inferencing of information, such as image recognition, speech recognition, or other artificial intelligence services.

Inference and/or training logic 715 are used to perform inferencing and/or training operations associated with one or more embodiments. In at least one embodiment, inference and/or training logic 715 may be used in system FIG. 7 for inferencing or predicting operations based, at least in part, on weight parameters calculated using neural network training operations, neural network functions and/or architectures, or neural network use cases described herein.

Such components can be used for multi-processor aggregation, transmission, and review.

### Computer Systems

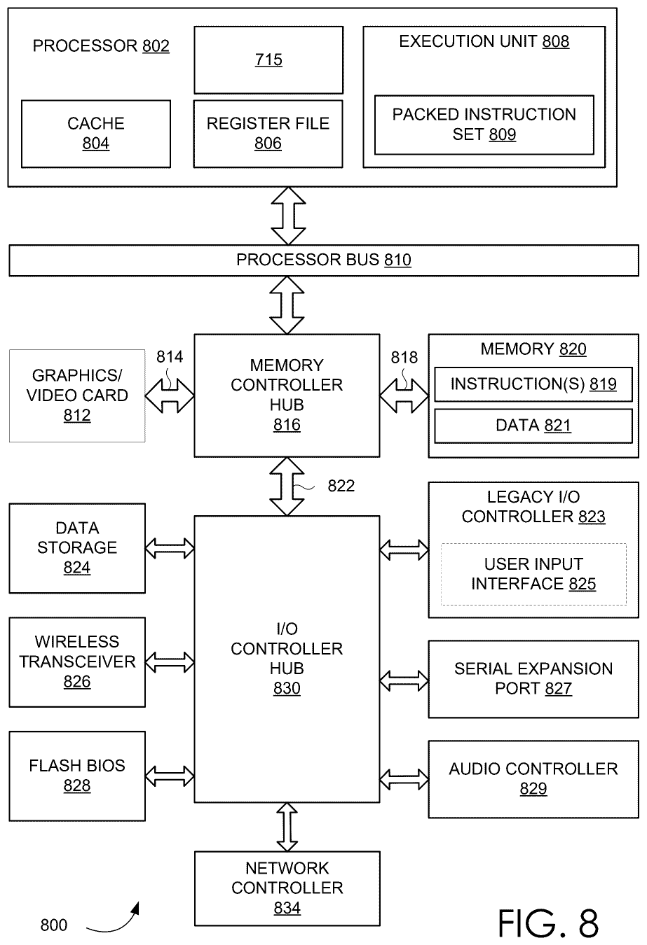

FIG. 8 is a block diagram illustrating an exemplary computer system, which may be a system with interconnected devices and components, a system-on-a-chip (SOC) or some combination thereof 800 formed with a processor that may include execution units to execute an instruction, according to at least one embodiment. In at least one embodiment, computer system 800 may include, without limitation, a component, such as a processor 802 to employ execution units including logic to perform algorithms for process data, in accordance with present disclosure, such as in embodiment described herein. In at least one embodiment, computer system 800 may include processors, such as PENTIUM® Processor family, Xeon™, Itanium®, XScale™ and/or StrongARM™, Intel® Core™, or Intel® Nervana™ microprocessors available from Intel Corporation of Santa Clara, California, although other systems (including PCs having other microprocessors, engineering workstations, set-top boxes and like) may also be used. In at least one embodiment, computer system 800 may execute a version of WINDOWS' operating system available from Microsoft Corporation of Redmond, Wash., although other operating systems (UNIX and Linux for example), embedded software, and/or graphical user interfaces, may also be used.

Embodiments may be used in other devices such as handheld devices and embedded applications. Some examples of handheld devices include cellular phones, Internet Protocol devices, digital cameras, personal digital assistants (“PDAs”), and handheld PCs. In at least one embodiment, embedded applications may include a microcontroller, a digital signal processor (“DSP”), system on a chip, network computers (“NetPCs”), set-top boxes, network hubs, wide area network (“WAN”) switches, or any other system that may perform one or more instructions in accordance with at least one embodiment.

In at least one embodiment, computer system 800 may include, without limitation, processor 802 that may include, without limitation, one or more execution units 808 to perform machine learning model training and/or inferencing according to techniques described herein. In at least one embodiment, computer system 800 is a single processor desktop or server system, but in another embodiment computer system 800 may be a multiprocessor system. In at least one embodiment, processor 802 may include, without limitation, a complex instruction set computer (“CISC”) microprocessor, a reduced instruction set computing (“RISC”) microprocessor, a very long instruction word (“VLIW”) microprocessor, a processor implementing a combination of instruction sets, or any other processor device, such as a digital signal processor, for example. In at least one embodiment, processor 802 may be coupled to a processor bus 810 that may transmit data signals between processor 802 and other components in computer system 800.

In at least one embodiment, processor 802 may include, without limitation, a Level 1 (“L1”) internal cache memory (“cache”) 804. In at least one embodiment, processor 802 may have a single internal cache or multiple levels of internal cache. In at least one embodiment, cache memory may reside external to processor 802. Other embodiments may also include a combination of both internal and external caches depending on particular implementation and needs. In at least one embodiment, register file 806 may store different types of data in various registers including, without limitation, integer registers, floating point registers, status registers, and instruction pointer register.

In at least one embodiment, execution unit 808, including, without limitation, logic to perform integer and floating point operations, also resides in processor 802. In at least one embodiment, processor 802 may also include a microcode (“ucode”) read only memory (“ROM”) that stores microcode for certain macro instructions. In at least one embodiment, execution unit 808 may include logic to handle a packed instruction set 809. In at least one embodiment, by including packed instruction set 809 in an instruction set of a general-purpose processor 802, along with associated circuitry to execute instructions, operations used by many multimedia applications may be performed using packed data in a general-purpose processor 802. In one or more embodiments, many multimedia applications may be accelerated and executed more efficiently by using full width of a processor's data bus for performing operations on packed data, which may eliminate need to transfer smaller units of data across processor's data bus to perform one or more operations one data element at a time.

In at least one embodiment, execution unit 808 may also be used in microcontrollers, embedded processors, graphics devices, DSPs, and other types of logic circuits. In at least one embodiment, computer system 800 may include, without limitation, a memory 820. In at least one embodiment, memory 820 may be implemented as a Dynamic Random Access Memory (“DRAM”) device, a Static Random Access Memory (“SRAM”) device, flash memory device, or other memory device. In at least one embodiment, memory 820 may store instruction(s) 819 and/or data 821 represented by data signals that may be executed by processor 802.

In at least one embodiment, system logic chip may be coupled to processor bus 810 and memory 820. In at least one embodiment, system logic chip may include, without limitation, a memory controller hub (“MCH”) 816, and processor 802 may communicate with MCH 816 via processor bus 810. In at least one embodiment, MCH 816 may provide a high bandwidth memory path 818 to memory 820 for instruction and data storage and for storage of graphics commands, data and textures. In at least one embodiment, MCH 816 may direct data signals between processor 802, memory 820, and other components in computer system 800 and to bridge data signals between processor bus 810, memory 820, and a system I/O 822. In at least one embodiment, system logic chip may provide a graphics port for coupling to a graphics controller. In at least one embodiment, MCH 816 may be coupled to memory 820 through a high bandwidth memory path 818 and graphics/video card 812 may be coupled to MCH 816 through an Accelerated Graphics Port (“AGP”) interconnect 814.

In at least one embodiment, computer system 800 may use system I/O 822 that is a proprietary hub interface bus to couple MCH 816 to I/O controller hub (“ICH”) 830. In at least one embodiment, ICH 830 may provide direct connections to some I/O devices via a local I/O bus. In at least one embodiment, local I/O bus may include, without limitation, a high-speed I/O bus for connecting peripherals to memory 820, chipset, and processor 802. Examples may include, without limitation, an audio controller 829, a firmware hub (“flash BIOS”) 828, a wireless transceiver 826, a data storage 824, a legacy I/O controller 823 containing user input and keyboard interface(s) 825, a serial expansion port 827, such as Universal Serial Bus (“USB”), and a network controller 834. Data storage 824 may comprise a hard disk drive, a floppy disk drive, a CD-ROM device, a flash memory device, or other mass storage device.

In at least one embodiment, FIG. 8 illustrates a system, which includes interconnected hardware devices or “chips”, whereas in other embodiments, FIG. 8 may illustrate an exemplary System on a Chip (“SoC”). In at least one embodiment, devices may be interconnected with proprietary interconnects, standardized interconnects (e.g., PCIe) or some combination thereof. In at least one embodiment, one or more components of computer system 800 are interconnected using compute express link (CXL) interconnects.

Inference and/or training logic 715 are used to perform inferencing and/or training operations associated with one or more embodiments. In at least one embodiment, inference and/or training logic 715 may be used in system FIG. 8 for inferencing or predicting operations based, at least in part, on weight parameters calculated using neural network training operations, neural network functions and/or architectures, or neural network use cases described herein.

Such components can be used for multi-processor aggregation, transmission, and review.

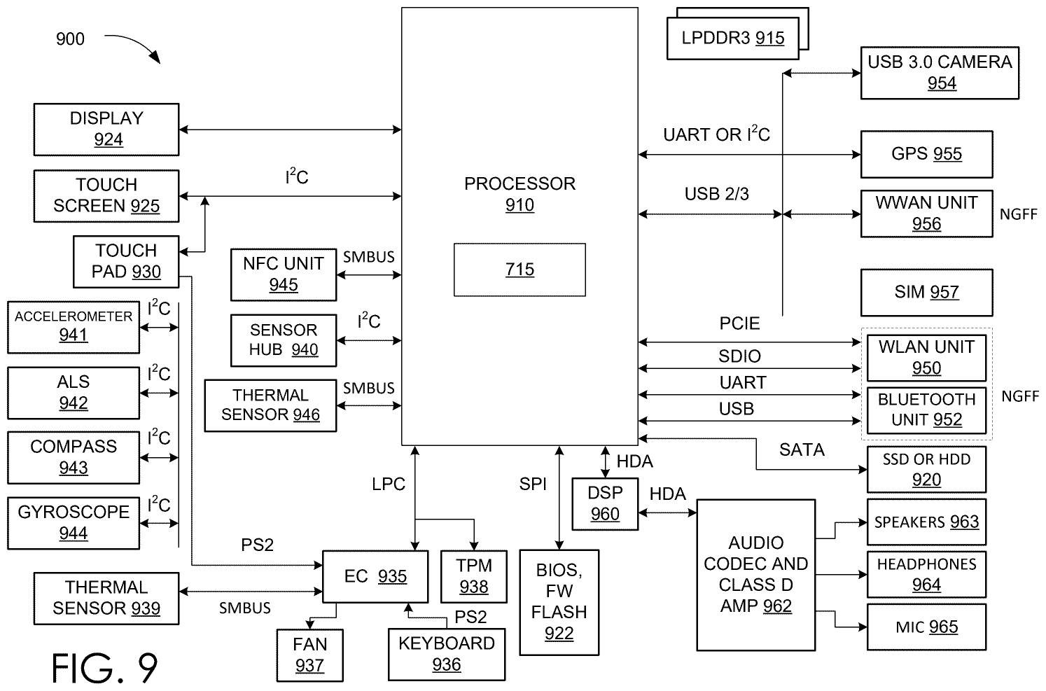

FIG. 9 is a block diagram illustrating an electronic device 900 for utilizing a processor 910, according to at least one embodiment. In at least one embodiment, electronic device 900 may be, for example and without limitation, a notebook, a tower server, a rack server, a blade server, a laptop, a desktop, a tablet, a mobile device, a phone, an embedded computer, or any other suitable electronic device.

In at least one embodiment, electronic device 900 may include, without limitation, processor 910 communicatively coupled to any suitable number or kind of components, peripherals, modules, or devices. In at least one embodiment, processor 910 coupled using a bus or interface, such as a 1° C. bus, a System Management Bus (“SMBus”), a Low Pin Count (LPC) bus, a Serial Peripheral Interface (“SPI”), a High Definition Audio (“HDA”) bus, a Serial Advance Technology Attachment (“SATA”) bus, a Universal Serial Bus (“USB”) (versions 1, 2, 3), or a Universal Asynchronous Receiver/Transmitter (“UART”) bus. In at least one embodiment, FIG. 9 illustrates a system, which includes interconnected hardware devices or “chips”, whereas in other embodiments, FIG. 9 may illustrate an exemplary System on a Chip (“SoC”). In at least one embodiment, devices illustrated in FIG. 9 may be interconnected with proprietary interconnects, standardized interconnects (e.g., PCIe) or some combination thereof. In at least one embodiment, one or more components of FIG. 9 are interconnected using compute express link (CXL) interconnects.

In at least one embodiment, FIG. 9 may include a display 924, a touch screen 925, a touch pad 930, a Near Field Communications unit (“NFC”) 945, a sensor hub 940, a thermal sensor 946, an Express Chipset (“EC”) 935, a Trusted Platform Module (“TPM”) 938, BIOS/firmware/flash memory (“BIOS, FW Flash”) 922, a DSP 960, a drive 920 such as a Solid State Disk (“SSD”) or a Hard Disk Drive (“HDD”), a wireless local area network unit (“WLAN”) 950, a Bluetooth unit 952, a Wireless Wide Area Network unit (“WWAN”) 956, a Global Positioning System (GPS) 955, a camera (“USB 3.0 camera”) 954 such as a USB 3.0 camera, and/or a Low Power Double Data Rate (“LPDDR”) memory unit (“LPDDR3”) 915 implemented in, for example, LPDDR3 standard. These components may each be implemented in any suitable manner.

In at least one embodiment, other components may be communicatively coupled to processor 910 through components discussed above. In at least one embodiment, an accelerometer 941, Ambient Light Sensor (“ALS”) 942, compass 943, and a gyroscope 944 may be communicatively coupled to sensor hub 940. In at least one embodiment, thermal sensor 939, a fan 937, a keyboard 936, and a touch pad 930 may be communicatively coupled to EC 935. In at least one embodiment, speakers 963, headphones 964, and microphone (“mic”) 965 may be communicatively coupled to an audio unit (“audio codec and class d amp”) 962, which may in turn be communicatively coupled to DSP 960. In at least one embodiment, audio unit 964 may include, for example and without limitation, an audio coder/decoder (“codec”) and a class D amplifier. In at least one embodiment, SIM card (“SIM”) 957 may be communicatively coupled to WWAN unit 956. In at least one embodiment, components such as WLAN unit 950 and Bluetooth unit 952, as well as WWAN unit 956 may be implemented in a Next Generation Form Factor (“NGFF”).

Inference and/or training logic 715 are used to perform inferencing and/or training operations associated with one or more embodiments. In at least one embodiment, inference and/or training logic 715 may be used in system FIG. 9 for inferencing or predicting operations based, at least in part, on weight parameters calculated using neural network training operations, neural network functions and/or architectures, or neural network use cases described herein.

Such components can be used for multi-processor aggregation, transmission, and review.

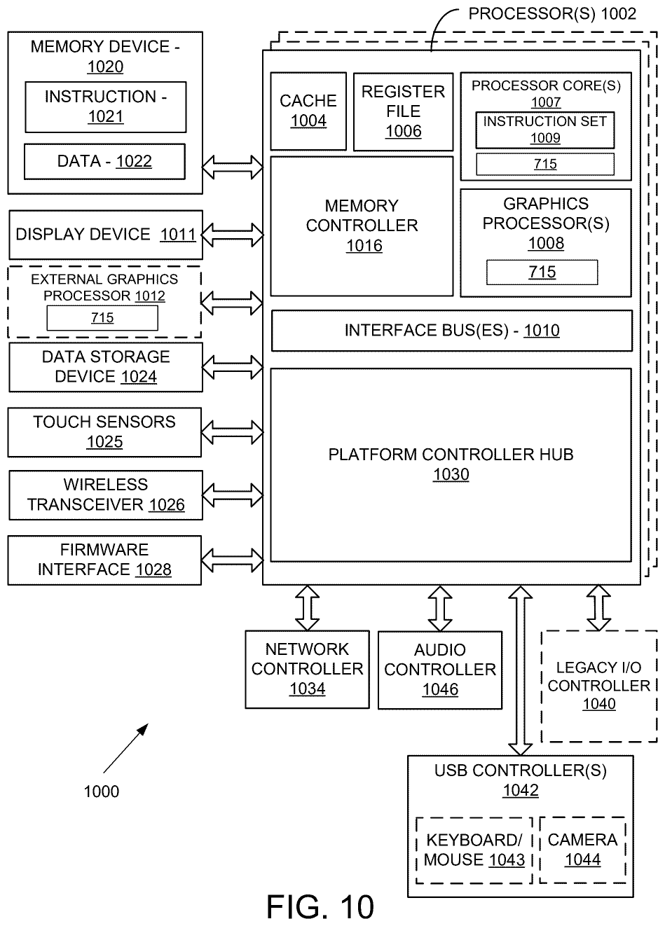

FIG. 10 is a block diagram of a processing system, according to at least one embodiment. In at least one embodiment, system 1000 includes one or more processor(s) 1002 and one or more graphics processor(s) 1008, and may be a single processor desktop system, a multiprocessor workstation system, or a server system having a large number of processor(s) 1002 or processor core(s) 1007. In at least one embodiment, system 1000 is a processing platform incorporated within a system-on-a-chip (SoC) integrated circuit for use in mobile, handheld, or embedded devices.

In at least one embodiment, system 1000 can include, or be incorporated within a server-based gaming platform, a game console, including a game and media console, a mobile gaming console, a handheld game console, or an online game console. In at least one embodiment, system 1000 is a mobile phone, smart phone, tablet computing device or mobile Internet device. In at least one embodiment, processing system 1000 can also include, couple with, or be integrated within a wearable device, such as a smart watch wearable device, smart eyewear device, augmented reality device, or virtual reality device. In at least one embodiment, processing system 1000 is a television or set top box device having one or more processor(s) 1002 and a graphical interface generated by one or more graphics processor(s) 1008.

In at least one embodiment, one or more processor(s) 1002 each include one or more processor core(s) 1007 to process instructions which, when executed, perform operations for system and user software. In at least one embodiment, each of one or more processor core(s) 1007 is configured to process a specific instruction set 1009. In at least one embodiment, instruction set 1009 may facilitate Complex Instruction Set Computing (CISC), Reduced Instruction Set Computing (RISC), or computing via a Very Long Instruction Word (VLIW). In at least one embodiment, processor core(s) 1007 may each process a different instruction set 1009, which may include instructions to facilitate emulation of other instruction sets. In at least one embodiment, processor core(s) 1007 may also include other processing devices, such a Digital Signal Processor (DSP).

In at least one embodiment, processor(s) 1002 includes cache memory 1004. In at least one embodiment, processor(s) 1002 can have a single internal cache or multiple levels of internal cache. In at least one embodiment, cache memory is shared among various components of processor(s) 1002. In at least one embodiment, processor(s) 1002 also uses an external cache (e.g., a Level-3 (L3) cache or Last Level Cache (LLC)) (not shown), which may be shared among processor core(s) 1007 using known cache coherency techniques. In at least one embodiment, register file 1006 is additionally included in processor(s) 1002 which may include different types of registers for storing different types of data (e.g., integer registers, floating point registers, status registers, and an instruction pointer register). In at least one embodiment, register file 1006 may include general-purpose registers or other registers.

In at least one embodiment, one or more processor(s) 1002 are coupled with one or more interface bus(es) 1010 to transmit communication signals such as address, data, or control signals between processor(s) 1002 and other components in system 1000. In at least one embodiment, interface bus(es) 1010, in one embodiment, can be a processor bus, such as a version of a Direct Media Interface (DMI) bus. In at least one embodiment, interface bus(es) 1010 is not limited to a DMI bus, and may include one or more Peripheral Component Interconnect buses (e.g., PCI, PCI Express), memory busses, or other types of interface busses. In at least one embodiment processor(s) 1002 include an integrated memory controller 1016 and a platform controller hub 1030. In at least one embodiment, memory controller 1016 facilitates communication between a memory device and other components of system 1000, while platform controller hub (PCH) 1030 provides connections to I/O devices via a local I/O bus.

In at least one embodiment, memory device 1020 can be a dynamic random access memory (DRAM) device, a static random access memory (SRAM) device, flash memory device, phase-change memory device, or some other memory device having suitable performance to serve as process memory. In at least one embodiment memory device 1020 can operate as system memory for system 1000, to store data 1022 and instruction 1021 for use when one or more processor(s) 1002 executes an application or process. In at least one embodiment, memory controller 1016 also couples with an optional external graphics processor 1012, which may communicate with one or more graphics processor(s) 1008 in processor(s) 1002 to perform graphics and media operations. In at least one embodiment, a display device 1011 can connect to processor(s) 1002. In at least one embodiment display device 1011 can include one or more of an internal display device, as in a mobile electronic device or a laptop device or an external display device attached via a display interface (e.g., DisplayPort, etc.). In at least one embodiment, display device 1011 can include a head mounted display (HMD) such as a stereoscopic display device for use in virtual reality (VR) applications or augmented reality (AR) applications.

In at least one embodiment, platform controller hub 1030 enables peripherals to connect to memory device 1020 and processor(s) 1002 via a high-speed I/O bus. In at least one embodiment, I/O peripherals include, but are not limited to, an audio controller 1046, a network controller 1034, a firmware interface 1028, a wireless transceiver 1026, touch sensors 1025, a data storage device 1024 (e.g., hard disk drive, flash memory, etc.). In at least one embodiment, data storage device 1024 can connect via a storage interface (e.g., SATA) or via a peripheral bus, such as a Peripheral Component Interconnect bus (e.g., PCI, PCI Express). In at least one embodiment, touch sensors 1025 can include touch screen sensors, pressure sensors, or fingerprint sensors. In at least one embodiment, wireless transceiver 1026 can be a Wi-Fi transceiver, a Bluetooth transceiver, or a mobile network transceiver such as a 3G, 4G, or Long Term Evolution (LTE) transceiver. In at least one embodiment, firmware interface 1028 enables communication with system firmware, and can be, for example, a unified extensible firmware interface (UEFI). In at least one embodiment, network controller 1034 can enable a network connection to a wired network. In at least one embodiment, a high-performance network controller (not shown) couples with interface bus(es) 1010. In at least one embodiment, audio controller 1046 is a multi-channel high definition audio controller. In at least one embodiment, system 1000 includes an optional legacy I/O controller 1040 for coupling legacy (e.g., Personal System 2 (PS/2)) devices to system. In at least one embodiment, platform controller hub 1030 can also connect to one or more Universal Serial Bus (USB) controller(s) 1042 connect input devices, such as keyboard and mouse 1043 combinations, a camera 1044, or other USB input devices.

In at least one embodiment, an instance of memory controller 1016 and platform controller hub 1030 may be integrated into a discreet external graphics processor, such as external graphics processor 1012. In at least one embodiment, platform controller hub 1030 and/or memory controller 1016 may be external to one or more processor(s) 1002. For example, in at least one embodiment, system 1000 can include an external memory controller 1016 and platform controller hub 1030, which may be configured as a memory controller hub and peripheral controller hub within a system chipset that is in communication with processor(s) 1002.

Inference and/or training logic 715 are used to perform inferencing and/or training operations associated with one or more embodiments. In at least one embodiment portions or all of inference and/or training logic 715 may be incorporated into graphics processor(s) 1008. For example, in at least one embodiment, training and/or inferencing techniques described herein may use one or more of ALUs embodied in a graphics processor. In at least one embodiment, weight parameters may be stored in on-chip or off-chip memory and/or registers (shown or not shown) that configure ALUs of a graphics processor to perform one or more machine learning algorithms, neural network architectures, use cases, or training techniques described herein.

Such components can be used for multi-processor aggregation, transmission, and review.

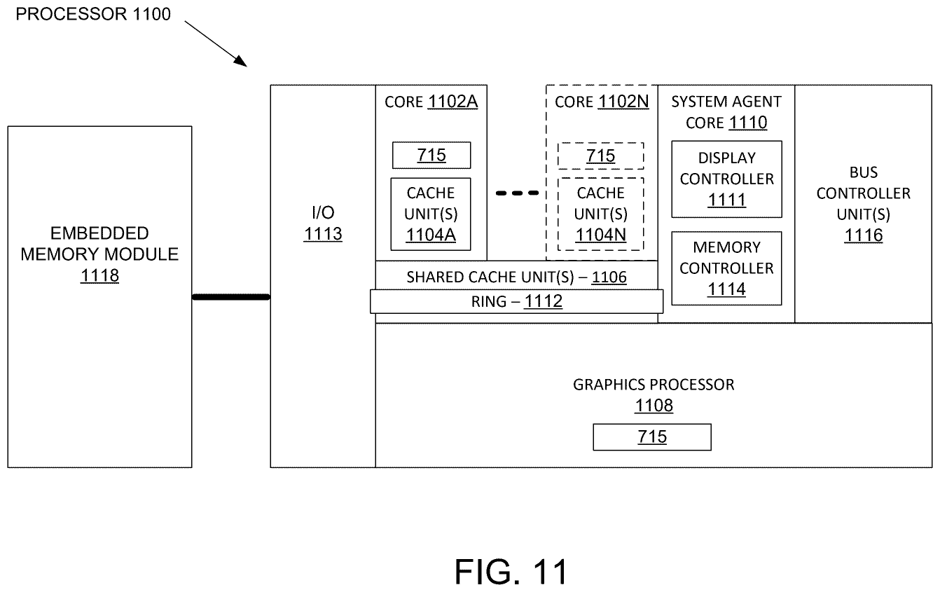

FIG. 11 is a block diagram of a processor 1100 having one or more processor core(s) 1102A-1102N, an integrated memory controller 1114, and an integrated graphics processor 1108, according to at least one embodiment. In at least one embodiment, processor 1100 can include additional cores up to and including additional core 1102N represented by dashed lined boxes. In at least one embodiment, each of processor core(s) 1102A-1102N includes one or more internal cache unit(s) 1104A-1104N. In at least one embodiment, each processor core also has access to one or more shared cached unit(s) 1106.

In at least one embodiment, internal cache unit(s) 1104A-1104N and shared cache unit(s) 1106 represent a cache memory hierarchy within processor 1100. In at least one embodiment, cache unit(s) 1104A-1104N may include at least one level of instruction and data cache within each processor core and one or more levels of shared mid-level cache, such as a Level 2 (L2), Level 3 (L3), Level 4 (L4), or other levels of cache, where a highest level of cache before external memory is classified as an LLC. In at least one embodiment, cache coherency logic maintains coherency between various cache unit(s) 1106 and 1104A-1104N.

In at least one embodiment, processor 1100 may also include a set of one or more bus controller unit(s) 1116 and a system agent core 1110. In at least one embodiment, one or more bus controller unit(s) 1116 manage a set of peripheral buses, such as one or more PCI or PCI express busses. In at least one embodiment, system agent core 1110 provides management functionality for various processor components. In at least one embodiment, system agent core 1110 includes one or more integrated memory controllers 1114 to manage access to various external memory devices (not shown).

In at least one embodiment, one or more of processor core(s) 1102A-1102N include support for simultaneous multi-threading. In at least one embodiment, system agent core 1110 includes components for coordinating and operating processor core(s) 1102A-1102N during multi-threaded processing. In at least one embodiment, system agent core 1110 may additionally include a power control unit (PCU), which includes logic and components to regulate one or more power states of processor core(s) 1102A-1102N and graphics processor 1108.

In at least one embodiment, processor 1100 additionally includes graphics processor 1108 to execute graphics processing operations. In at least one embodiment, graphics processor 1108 couples with shared cache unit(s) 1106, and system agent core 1110, including one or more integrated memory controllers 1114. In at least one embodiment, system agent core 1110 also includes a display controller 1111 to drive graphics processor output to one or more coupled displays. In at least one embodiment, display controller 1111 may also be a separate module coupled with graphics processor 1108 via at least one interconnect, or may be integrated within graphics processor 1108.

In at least one embodiment, a ring based interconnect unit 1112 is used to couple internal components of processor 1100. In at least one embodiment, an alternative interconnect unit may be used, such as a point-to-point interconnect, a switched interconnect, or other techniques. In at least one embodiment, graphics processor 1108 couples with ring based interconnect unit 1112 via an I/O link 1113.

In at least one embodiment, I/O link 1113 represents at least one of multiple varieties of I/O interconnects, including an on package I/O interconnect which facilitates communication between various processor components and a high-performance embedded memory module 1118, such as an eDRAM module. In at least one embodiment, each of processor core(s) 1102A-1102N and graphics processor 1108 use embedded memory modules 1118 as a shared Last Level Cache.

In at least one embodiment, processor core(s) 1102A-1102N are homogenous cores executing a common instruction set architecture. In at least one embodiment, processor core(s) 1102A-1102N are heterogeneous in terms of instruction set architecture (ISA), where one or more of processor core(s) 1102A-1102N execute a common instruction set, while one or more other cores of processor core(s) 1102A-1102N executes a subset of a common instruction set or a different instruction set. In at least one embodiment, processor core(s) 1102A-1102N are heterogeneous in terms of microarchitecture, where one or more cores having a relatively higher power consumption couple with one or more power cores having a lower power consumption. In at least one embodiment, processor 1100 can be implemented on one or more chips or as an SoC integrated circuit.

Inference and/or training logic 715 are used to perform inferencing and/or training operations associated with one or more embodiments. In at least one embodiment portions or all of inference and/or training logic 715 may be incorporated into processor 1100. For example, in at least one embodiment, training and/or inferencing techniques described herein may use one or more of ALUs embodied in graphics processor 1108, processor core(s) 1102A-1102N, or other components in FIG. 11. In at least one embodiment, weight parameters may be stored in on-chip or off-chip memory and/or registers (shown or not shown) that configure ALUs of graphics processor 1100/1108 to perform one or more machine learning algorithms, neural network architectures, use cases, or training techniques described herein.

Such components can be used for multi-processor aggregation, transmission, and review.

Various embodiments can be described by the following clauses:
1. A processor comprising:
one or more processing circuits to:
receive, from a plurality of central processing units (CPUs), a plurality of input signals corresponding to respective boot progress codes;
select, from the plurality of input signals, a first input signal;
verify a start sequence and an address for the first input signal; and
transmit the first input signal to a receiver while executing a clock stretch for the remaining input signals of the plurality of input signals.
2. The processor of clause 1, wherein the one or more processing circuits are further to:
determine an end sequence for the first input signal;
select a second input signal from the plurality of input signals; and
transmit the second input signal to the receiver while maintaining the clock stretch for the remaining input signals of the plurality of input signals.
3. The processor of clause 2, wherein the second input signal is selected based on at least one of a round robin rule, a weighted selection rule, or a combination thereof.
4. The processor of clause 1, wherein the receiver is a baseboard management controller and the first input signal is transmitted using an inter integrated-circuit protocol.
5. The processor of clause 1, wherein the first input signal is transmitted on a byte-basis.
6. The processor of clause 1, wherein the one or more processing circuits are further to:
store the first input signal within a buffer;
store a selected second input signal to the buffer; and
transmit, from the buffer, the first input signal and the second input signal to the receiver.
7. The processor of clause 1, wherein the processor is incorporated into at least one of:
a field programmable gate array (FPGA);
an application-specific integrated circuit (ASIC);
a system on chip (SoC); or
a complex programmable logic device (CPLD).
8. A system, comprising:
a plurality of processing units (PUs), each PU of the plurality of PUs including an output data path to transmit respective processor information signals;
a baseboard management controller (BMC) configured to receive the respective processor information signals; and
an aggregator communicatively coupled between the plurality of PUs and the BMC, wherein each output data path for the PUs of the plurality of PUs is coupled to the aggregator and the aggregator is configured to:
   receive the respective processor information signals from the plurality of PUs;
   identify, based at least in part on a start sequence and an address, a first processor information signal;
   transmit a first data stream associated with the first processor information signal to the BMC; and
   maintain the remaining PUs in a clock stretch operating condition while transmitting the first data stream.
9. The system of clause 8, wherein the plurality of PUs include at least one of a central processing unit (CPU), a data processing unit (DPU), or a graphics processing unit (GPU).
10. The system of clause 8, wherein the respective processor information signals include at least one of boot codes, debug codes, logging data, or sensor information.
11. The system of clause 8, wherein the processor information signals further comprise a source header associated with the respective PU generating or transmitting the processor information signals.
12. The system of clause 8, wherein at least one output data path is transmitted using at least one of an inter integrated-circuit (I2C) communication protocol, a serial peripheral interface (SPI) communication protocol, a universal asynchronous receiver/transmitter (UART) communication protocol, a system management bus (SMBus) communication protocol, or an improved inter integrated-circuit (I3C) communication protocol.
13. The system of clause 8, wherein a first PU of the plurality of PUs is local to the aggregator and a second PU of the plurality of PUs is remote from the aggregator.
14. The system of clause 8, wherein the aggregator is further configured to:
store the first data stream in a buffer;
identify a second data stream associated with a second processor information signal;
store the second data stream in the buffer; and
transmit the second data stream to the BMC.
15. The system of clause 8, wherein the aggregator includes at least one of:
a field programmable gate array (FPGA);
an application-specific integrated circuit (ASIC);
a system on chip (SoC); or
a complex programmable logic device (CPLD).
16. The system of clause 8, wherein each output data path for the respective PUs of the plurality of PUs is not directly coupled to the BMC for transmission of the respective processor information signals.
17. A system, comprising:
a plurality of processing units (PUs), each PU of the plurality of PUs including an output data path to transmit respective processor information signals;
a controller configured to receive the respective processor information signals; and
an aggregator communicatively between the plurality of PUs and the controller;
wherein each output data path for the respective PUs of the plurality of PUs is coupled to the aggregator, a processor information signal communication path is formed between the controller and the aggregator, and the plurality of PUs are not directly coupled to the controller with individual processor information signal communication paths.
18. The system of clause 17, wherein the plurality of PUs include at least one of a central processing unit (CPU), a data processing unit (DPU), or a graphics processing unit (GPU).
19. The system of clause 17, wherein the respective processor information signals include at least one of boot codes, debug codes, logging data, or sensor information.
20. The system of clause 17, wherein a first PU of the plurality of PUs is local to the aggregator and a second PU of the plurality of PUs is remote from the aggregator.

Other variations are within spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. Term “connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. Use of term “set” (e.g., “a set of items”) or “subset,” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B, and at least one of C each to be present. In addition, unless otherwise noted or contradicted by context, term “plurality” indicates a state of being plural (e.g., “a plurality of items” indicates multiple items). A plurality is at least two items, but can be more when so indicated either explicitly or by context. Further, unless stated otherwise or otherwise clear from context, phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. A set of non-transitory computer-readable storage media, in at least one embodiment, comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors—for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. Terms “system” and “method” are used herein interchangeably insofar as system may embody one or more methods and methods may be considered a system.

In present document, references may be made to obtaining, acquiring, receiving, or inputting analog or digital data into a subsystem, computer system, or computer-implemented machine. Obtaining, acquiring, receiving, or inputting analog and digital data can be accomplished in a variety of ways such as by receiving data as a parameter of a function call or a call to an application programming interface. In some implementations, process of obtaining, acquiring, receiving, or inputting analog or digital data can be accomplished by transferring data via a serial or parallel interface. In another implementation, process of obtaining, acquiring, receiving, or inputting analog or digital data can be accomplished by transferring data via a computer network from providing entity to acquiring entity. References may also be made to providing, outputting, transmitting, sending, or presenting analog or digital data. In various examples, process of providing, outputting, transmitting, sending, or presenting analog or digital data can be accomplished by transferring data as an input or output parameter of a function call, a parameter of an application programming interface or interprocess communication mechanism.

Although discussion above sets forth example implementations of described techniques, other architectures may be used to implement described functionality, and are intended to be within scope of this disclosure. Furthermore, although specific distributions of responsibilities are defined above for purposes of discussion, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A processor comprising:
one or more processing circuits to:
receive, from a plurality of central processing units (CPUs), a plurality of input signals corresponding to respective boot progress codes;
select, from the plurality of input signals, a first input signal;
verify a start sequence and an address for the first input signal; and
transmit the first input signal to a receiver while executing a clock stretch for the remaining input signals of the plurality of input signals.

2. The processor of claim 1, wherein the one or more processing circuits are further to:
determine an end sequence for the first input signal;
select a second input signal from the plurality of input signals; and
transmit the second input signal to the receiver while maintaining the clock stretch for the remaining input signals of the plurality of input signals.

3. The processor of claim 2,, wherein the second input signal is selected based on at least one of a round robin rule, a weighted selection rule, or a combination thereof.

4. The processor of claim 1, wherein the receiver is a baseboard management controller and the first input signal is transmitted using an inter integrated-circuit protocol.

5. The processor of claim 1, wherein the first input signal is transmitted on a byte-basis.

6. The processor of claim 1, wherein the one or more processing circuits are further to:
store the first input signal within a buffer;
store a selected second input signal to the buffer; and
transmit, from the buffer, the first input signal and the second input signal to the receiver.

7. The processor of claim 1, wherein the processor is incorporated into at least one of:
a field programmable gate array (FPGA);
an application-specific integrated circuit (ASIC);
a system on chip (SoC); or
a complex programmable logic device (CPLD).

8. A system, comprising:
a plurality of processing units (PUs), each PU of the plurality of PUs including an output data path to transmit respective processor information signals;
a baseboard management controller (BMC) configured to receive the respective processor information signals; and
an aggregator communicatively coupled between the plurality of PUs and the BMC, wherein each output data path for the PUs of the plurality of PUs is coupled to the aggregator and the aggregator is configured to:
receive the respective processor information signals from the plurality of PUs;
identify, based at least in part on a start sequence and an address, a first processor information signal;
transmit a first data stream associated with the first processor information signal to the BMC; and
maintain the remaining PUs in a clock stretch operating condition while transmitting the first data stream.

9. The system of claim 8, wherein the plurality of PUs include at least one of a central processing unit (CPU), a data processing unit (DPU), or a graphics processing unit (GPU).

10. The system of claim 8, wherein the respective processor information signals include at least one of boot codes, debug codes, logging data, or sensor information.

11. The system of claim 8, wherein the processor information signals further comprise a source header associated with the respective PU generating or transmitting the processor information signals.

12. The system of claim 8, wherein at least one output data path is transmitted using at least one of an inter integrated-circuit (I2C) communication protocol, a serial peripheral interface (SPI) communication protocol, a universal asynchronous receiver/transmitter (UART) communication protocol, a system management bus (SMBus) communication protocol, or an improved inter integrated-circuit (I3C) communication protocol.

13. The system of claim 8, wherein a first PU of the plurality of PUs is local to the aggregator and a second PU of the plurality of PUs is remote from the aggregator.

14. The system of claim 8, wherein the aggregator is further configured to:
store the first data stream in a buffer;
identify a second data stream associated with a second processor information signal;
store the second data stream in the buffer; and
transmit the second data stream to the BMC.

15. The system of claim 8, wherein the aggregator includes at least one of:
a field programmable gate array (FPGA);
an application-specific integrated circuit (ASIC);
a system on chip (SoC); or
a complex programmable logic device (CPLD).

16. The system of claim 8, wherein each output data path for the respective PUs of the plurality of PUs is not directly coupled to the BMC for transmission of the respective processor information signals.

17. A system, comprising:
a plurality of processing units (PUs), each PU of the plurality of PUs including an output data path to transmit respective processor information signals;
a controller configured to receive the respective processor information signals; and
an aggregator communicatively between the plurality of PUs and the controller;
wherein each output data path for the respective PUs of the plurality of PUs is coupled to the aggregator, a processor information signal communication path is formed between the controller and the aggregator, and the plurality of PUs are not directly coupled to the controller with individual processor information signal communication paths.

18. The system of claim 17, wherein the plurality of PUs include at least one of a central processing unit (CPU), a data processing unit (DPU), or a graphics processing unit (GPU).

19. The system of claim 17, wherein the respective processor information signals include at least one of boot codes, debug codes, logging data, or sensor information.

20. The system of claim 17, wherein a first PU of the plurality of PUs is local to the aggregator and a second PU of the plurality of PUs is remote from the aggregator.
